(19) United States
(12) Patent Application Publication
(10) Pub. No.: US 2025/0225802 A1
(43) Pub. Date: Jul. 10, 2025

(54) SYSTEMS AND METHODS FOR ATTRIBUTING IMAGE GENERATIVE MODELS USING LATENT FINGERPRINTS

(71) Applicants: Guangyu Nie, Tempe, AZ (US); Changhoon Kim, Tempe, AZ (US); Yezhou Yang, Phoenix, AZ (US); Yi Ren, Chandler, AZ (US)

(72) Inventors: Guangyu Nie, Tempe, AZ (US); Changhoon Kim, Tempe, AZ (US); Yezhou Yang, Phoenix, AZ (US); Yi Ren, Chandler, AZ (US)

(73) Assignee: Arizona Board of Regents on Behalf of Arizona State University, Tempe, AZ (US)

(21) Appl. No.: 19/011,264

(22) Filed: Jan. 6, 2025

Related U.S. Application Data
(60) Provisional application No. 63/618,192, filed on Jan. 5, 2024.

(51) Int. Cl. G06V 20/00; G06V 10/774; G06V 10/82; G06V 40/16

(52) U.S. Cl. CPC G06V 20/95; G06V 10/774; G06V 10/82; G06V 40/172

(57) ABSTRACT

Examples systems and methods for improved artificial intelligence generative model image attribution include a processor accessing instructions stored on a machine-readable storage medium. The instructions can be executable by the processor to obtain latent semantic dimensions by applying a principal component analysis on a latent distribution. Perturbations can be applied along the latent semantic dimensions according to a user-specific key and a predetermined perturbations strength to embed a model-specific fingerprint to embed a fingerprinted latent variable directly into the generative model such that the generative model generates images with model-specific fingerprints.

### CROSS REFERENCE TO RELATED APPLICATIONS

This is a non-provisional application that claims benefit to U.S. Provisional Application Ser. No. 63/618,192, filed on Jan. 5, 2024, which is herein incorporated by reference in its entirety.

### GOVERNMENT SUPPORT

This invention was made with government support under 2038666 and 2101052 awarded by the National Science Foundation. The government has certain rights in the invention.

### FIELD

The present disclosure generally relates to systems and methods for improving attribution of AI generated images to the generative models responsible for their production.

### BACKGROUND

Generative models can now create synthetic content such as images and audio that are indistinguishable from those captured in nature. This poses a serious threat when used for malicious purposes, such as disinformation and malicious impersonation. Such potential threats have slowed down the industrialization process of generative models, as conservative model inventors hesitate to release their source code. For example, in 2020, OpenAI refused to release the source code of their GPT-2 model due to concerns over potential malicious use. Additionally, the source code for DALL-E and DALL-E 2 has not been released for the same reason.

Blatant or obvious watermarking is not a viable option for overcoming the threat of synthetic content produced by generative models due to the existence of postprocessing. Because the watermark is obvious, individuals with malicious intent simply need to turn postprocessing of images to eliminate the attributable feature and hide their identity.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1A is a visual comparison between latent fingerprinting and shallow fingerprinting methods.;

FIG. 1B is a schematic of the latent fingerprinting method;

FIG. 2 is a comparison of fingerprints along minor and major principal components of the latent distribution produced by StyleGAN and LDM;

FIG. 3 is a comparison of generation quality between the latent fingerprinting and baseline methods with similar attribution accuracy; and

FIG. 4A is a plot of the average percentage error rate on the ground truth parameter a;

FIG. 4B is a depiction of fingerprints at various editing strengths;

FIG. 5 is a qualitative comparison of original and fingerprinted sample images.

FIG. 6 is an example process or method for implementing functionality described herein.

FIG. 7 is an example computing device for implementing functionality described herein.

Corresponding reference characters indicate corresponding elements among the view of the drawings. The headings used in the figures do not limit the scope of the claims.

### DETAILED DESCRIPTION

The present disclosure relates to systems and methods for improving attribution of generative models to mitigate the use of generated images for malicious purposes. One example method can include a processor accessing and executing instructions contained within a machine-readable storage medium. The instructions can be executed by the processor to transform an initial distribution of a user end generative model into a latent distribution. Principal component analysis can then be performed on the latent distribution to obtain a plurality of latent semantic dimensions. By applying perturbations along a subset of the plurality of latent semantic dimensions according to a user-specific key and a predetermined perturbation strength, a fingerprinted latent variable can be directly embedded into the user-end generative model. In doing so, the method allows for the user-end generative model to generate images with model-specific fingerprints.

In particular, a novel fingerprinting strategy that directly embeds fingerprints into a pretrained generative model, as a means to achieve responsible white-box model distribution is disclosed herein. The present disclosure also proves and empirically verifies that there exists an intrinsic tradeoff between attribution accuracy and generation quality. This tradeoff is affected by fingerprint variables including the choice of the fingerprinting space, the fingerprint strength, and its capacity. Parametric studies on these variables for StyleGAN2 (SG2) and a Latent Diffusion Model (LDM) lead to improved accuracy-quality tradeoff from the previous SOTA. In addition, the disclosed method requires negligible computation compared with previous SOTA, rendering it more applicable to popular large-scale models, including latent diffusion ones. The present disclosure further demonstrates that using a postprocess specific LPIPS metric for model attribution leads to further improved attribution accuracy against image postprocesses.

### 1. Introduction

One potential risk mitigation strategy is to attribute generative models via fingerprinting. Current fingerprinting methods exhibit a significant tradeoff between robust attribution accuracy and generation quality while lacking design principles to improve this tradeoff. The present disclosure investigates the use of latent semantic dimensions as fingerprints, from where the effects of design variables, including the choice of fingerprinting dimensions, strength, and capacity, on the accuracy quality tradeoff can be analyzed. Compared with previous SOTA, the disclosed method requires minimum computation and is more applicable to large-scale models. StyleGAN2 and the latent diffusion model are used to demonstrate the efficacy of the disclosed method.

Specifically the methods disclosed herein rely on model attribution, where the model distributor tweaks each user-end model to generate content with model-specific fingerprints. In practice, a scenario where the model distributor or regulator maintains a database of user-specific keys corresponding to each user's downloaded model is considered. In the event of a malicious attempt, the regulator can identify the user responsible for the attempt by using attribution.

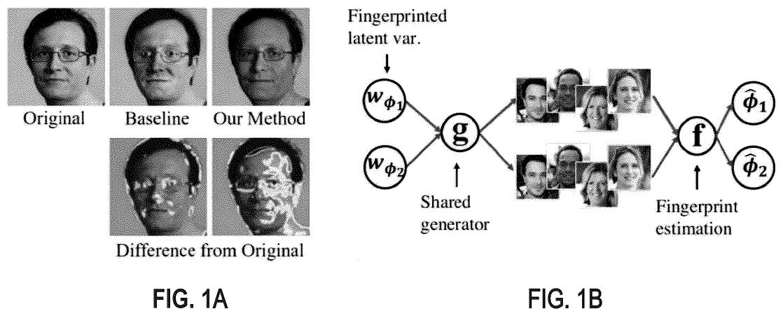

Formally, let a set of n generative models be [symbol] :={gᵢ(⋅)}ᵢ₌₁ⁿ, where gᵢ(⋅): [symbol] ^{d}^{_{z}}→ [symbol] ^{d}^{ₓ} is a mapping from an easy-to-sample distribution p_{z}, to a fingerprinted data distribution p_{x,i} in the content space, and is parameterized by a binary-coded key ϕᵢ∈Φ:={0, 1}^{d}^{_{ϕ}}. Let f(⋅) [symbol] ^{d}^{ₓ}→Φ be a mapping that attributes contents to their source models (FIG. 1(b)). The present disclosure considers four performance metrics of a fingerprinting mechanism: The attribution accuracy of gᵢ is defined as

$$A ( {g}_{i} ) = {𝔼}_{z \sim {p}_{z}} [ 𝕀 ( f ( {g}_{i} ( z ) ) == {ϕ}_{i} ) ] . \qquad ( 1 )$$

The generation quality of gᵢ measures the difference between p_{x,i} and the data distribution used for learning [symbol] , e.g., the Frechet Inception Distance (FID) score for images. Inception score (IS) is also measured for p_{x,i} as additional generation quality metrics. Fingerprint secrecy is measured by the mean structural similarity index measure (SSIM) of individual images drawn from p_{x,i}. Compared with generation quality, this metric focuses on how obvious fingerprints are rather than how well two content distributions match. Lastly, the fingerprint capacity is n=2^{d}^{_{ϕ}}.

Existing model attribution methods exhibit a significant tradeoff between attribution accuracy, generation quality, and secrecy, particularly when countermeasures against deattribution attempts, e.g., image postprocesses, are considered. For example, Kim et al. (2021) use shallow fingerprints for image generators in the form of gᵢ(z)=g₀(z)+ϕᵢ where g₀(⋅) is an unfingerprinted model and show that ϕᵢs have to significantly alter the original contents to achieve good attribution accuracy against image blurring, causing an unfavorable drop in generation quality and secrecy (FIG. 1(a)).

To improve this tradeoff, the present disclosure investigates latent fingerprints in the form of gᵢ(z)=g₀(ψ(z)+ϕᵢ), where w:=ψ(z)∈ [symbol] ^{d}^{_{w}} contains disentangled semantic dimensions that allow a smoother mapping to the content space (FIG. 1(a)). Such ψ has been incorporated in popular models such as StyleGAN (SG), where w is the style vector, and latent diffusion models (LDM), where w comes from a diffusion process. Existing studies on semantic editing showed that [symbol] ^{d}^{_{w}} consists of linear semantic dimensions. Inspired by this, the present disclosure hypothesizes that using subtle yet semantic changes as fingerprints will improve the robustness of attribution accuracy against image postprocesses, and thus investigates the performance of fingerprints that are generated by perturbations along latent dimensions of [symbol] ^{d}^{_{w}}. Specifically, latent dimensions as eigenvectors of the covariance matrix of the latent distribution p_{w}, denoted by Σ_{w} are considered.

### 2. Additional Introduction

Model attribution through fingerprint encoding and decoding. Yu et al. (2020) propose to encode binary-coded keys into images through gᵢ(z)=g₀([z, ϕᵢ]) and to decode them via another learnable function. This requires joint training of the encoder and decoder over [symbol] ^{d}^{_{z}}×Φ to empirically balance attribution accuracy and generation quality. Since fingerprint capacity is usually high (i.e., 2^{d}^{_{ϕ}}), training is made tractable by sampling only a small subset of fingerprints. Thus, this method is computationally expensive and lacks a principled understanding of how the fingerprinting mechanism affects the accuracy-quality tradeoff. In contrast, the disclosed method does not require any additional training and mainly relies on simple principle component analysis of the latent distribution.

Certifiable model attribution through shallow fingerprints. Kim et al. (2021) propose shallow fingerprints gᵢ(z)=g₀+ϕᵢ and linear classifiers for attribution. These simplifications allow the derivation of sufficient conditions of Φ to achieve certifiable attribution of [symbol] . Since the fingerprints are added as noises rather than semantic changes coherent with the generated contents, increased noise strength becomes necessary to maintain attribution accuracy under postprocesses. While the present disclosure does not provide attribution certification for latent fingerprints, it does discuss the technical feasibility and challenges in achieving this goal.

StyleGAN and low-rank subspace. The present study focuses on popular image generation models which share an architecture rooted in SG: A Gaussian distribution is first transformed into a latent distribution (p_{w}), samples from which are then decoded into images. Harkonen et al. (2020) apply principal component analysis on p_{w} distribution and found semantically meaningful editing directions. Zhu et al. (2021) use local Jacobian (∇_{w}g) to derive perturbations that enable local semantic editing of generated images, and show that such semantic dimensions are shared across the latent space. In the present disclosure, it is shown that the mean of the Gram matrix for local editing ( [symbol] _{w˜p}_{_{w}}[∇_{w}g^{T}∇_{w}g]) and the covariance of w(Σ_{w}) are qualitatively similar in that both reveal major to minor semantic dimensions through their eigenvectors.

GAN inversion. The model attribution problem can be formulated as a GAN inversion problem. A learning based inversion optimizes parameters of the encoder network which map an image to latent code z. On the other hand, optimization based inversion solve for latent code z that minimizes distance metric between a given image and generated image g(z). The learning based method is computationally more efficient in the inference stage compared to optimization based method. However, optimization based GAN inversion achieves a superior quality of latent interpretation, which can be referred to as the quality time tradeoff. The disclosed method utilized the optimization based inversion. To enforce faithful latent interpretation, the disclosed method incorporates existing techniques, e.g., parallel search, to solve this non-convex problem, but uniquely exploits the fact that fingerprints are small latent perturbations to enable analysis on the accuracy quality tradeoff.

### 3. Methods

### 3.1 Notations and Preliminaries Notations

For x∈ [symbol] ⁿ and A∈ [symbol] ^{n×m}, denote by proj_{A}_{^{x}} the projection of x to span(A), and by A^{†}the pseudo inverse of A. For parameter a, denote by \hat{α} its estimate and ∈_{α}=\hat{α}−α the error. ∇ₓf is the gradient of f with respect to x, [symbol] _{x˜p}_{ₓ}[⋅] is an expectation over pₓ, and tr(B) (resp. det(B)) is the trace (resp. determinant) of B∈ [symbol] ^{n×n}. diag(λ)∈ [symbol] ^{n×n} diagonalizes λ∈ [symbol] ⁿ.

Latent Fingerprints. Contemporary generative models, e.g., SG2 and LDM, consist of a disentanglement mapping ψ:R^{d}^{_{z}}→R^{d}^{_{w}} from an easy-to-sample distribution p, to a latent distribution p_{w}, followed by a generator g:R^{d}^{_{w}}→R^{d}^{ₓ} that maps w to the content space. In particular, ψ is a multilayer perception network in SG2 and a diffusion process in a diffusion model. Existing studies showed that linear perturbations along principal components of ∇_{w}g enable semantic editing, and such perturbation directions are often applicable over w˜p_{w}. Indeed, instead of local analysis on the Jacobian, (Harkonen et al., 2020) showed that principal component analysis directly on p_{w} also reveals semantic dimensions. The present disclosure follows these existing findings and uses a subset of semantic dimensions as fingerprints. Specifically, let U∈ [symbol] ^{d}^{_{w}}^{×(d}^{_{w}}^{-d}^{_{ϕ)}} and V∈ [symbol] ^{d}^{_{w}}^{×d}^{_{ϕ}} be orthonormal and complementary. Given random seed z∈ [symbol] ^{d}^{_{z}}, user-specific key σ∈ [symbol] ^{d}^{_{ϕ}}, and strength σ∈ [symbol] , let α=U^{†}proj_{U}ψ(z)∈ [symbol] ^{d}^{_{w}}^{-d}^{_{ϕ}}, the fingerprinted latent variable is

$${w}_{ϕ} ( α ) = U α + σ V ϕ , \qquad ( 2 )$$

where α˜p_{α} and p_{α} is induced by p_{w}. Then, the model can generate fingerprinted images, g(w_{ϕ}(α)). The choice of (U, V) and σ affects the attribution accuracy and generalization performance, which is analyzed in Sec. 3.2.

Attribution. To decode user-specific key from the image g(w_{ϕ}(α)), an optimization problem is formulated:

$${min}_{\hat{α} , \hat{ϕ}} l ( g ( {w}_{\hat{ϕ}} ( \hat{α} ) ) , g ( {w}_{ϕ} ( α ) ) ) \\ s . t . {\hat{α}}_{i} ∈ [ {α}_{l , i} , {α}_{u , i} ] , ∀ i = 1 , … {d}_{w} - {d}_{ϕ}$$

While l is l₂ norm for analysis in Sec.3.2, here LPIPS is minimized, which measures the perceptual difference between two images. Through experiments, it was discovered that attribution accuracy can be improved by constraining a. Here the upper and lower bounds of α are chosen based on the empirical limits observed from p_{α}. In practice, a penalty on \hat{α} with large enough Lagrange multipliers is introduced and the resulting unconstrained problem is solved. To avoid convergence to unfavorable local solutions, the disclosed method also employs parallel search with n initial guesses of \hat{α} drawn through Latin hypercube sampling (LHS).

### 3.2 Accuracy-Quality Tradeoff

Attribution accuracy. Define J_{w}=∇g(w), H_{w}=J_{W}^{T}J_{w}. Let H̅_{w}= [symbol] _{w˜p}_{_{w}}[H_{w}] be the mean Gram matrix, and H̅_{ϕ}= [symbol] _{α˜p}_{_{α}}[H_{wϕ(α)}] be its fingerprinted version. Let l: [symbol] ^{d}^{ₓ}× [symbol] ^{d}^{ₓ}→ [symbol] be a distance metric between two images, (\hat{α}, \hat{ϕ}) the estimates. The following simplifications and assumptions are used to analyze how (V, U) affects the attribution accuracy: (A1) l(⋅,⋅) is the l₂ norm. (A2) Both ∥ϵ_{α}∥ and σ are small. In practice small ∥ϵ_{α}∥ is achieved through parallel search (see Appendix B). (A3) Since the focus is on ϵ_{∅}, one can further assume that the estimation of α, denoted by \hat{α}(α), is independent from ϕ, and ϵ_{α} is constant. This allows the subroutine for computing \hat{α}(α) to be ignored and turns the estimation problem into an optimization with respect to only ϵ_{ϕ}. Formally, we have the following proposition (see Appendix A.1 for proof):

Proposition 3.1. ∃c>0 such that if σ≤c and ∥ϵ_{α}∥₂≤c, the fingerprint estimation problem

$$\begin{matrix}min \\ ϕ\end{matrix} {𝔼}_{α \sim {p}_{α}} [ {‖ g ( {w}_{\hat{ϕ}} ( \hat{α} ( α ) ) ) - g ( {w}_{ϕ} ( α ) ) ‖}_{2}^{2} ] \\ has an error {ϵ}_{ϕ} = - {( {σ}^{2} {V}^{T} {\overline{H}}_{ϕ} V )}^{- 1} {V}^{T} {\overline{H}}_{ϕ} U {ϵ}_{α} .$$

TABLE 1
Attribution accuracy and generation quality of the proposed method. FID − g₀ and IS −
g₀ represent the baseline FID and inception score for the image quality of generative models prior
to fingerprinting. ↑ (↓) indicates higher (lower) is desired. The standard deviation is in parentheses.

| | | Attribution Accuracy | | | | | | | |
|---|---|---|---|---|---|---|---|---|---|
| | | | w/o α- | | Image Quality | | | | |
| Model | Dataset | Ours | reg | w/o LHS | FID − g₀ | FID↓ | IS − g₀ ↑ | IS ↑ | SSIM ↑ |
| SG2 | FFHQ | 0.983 | 0.877 | 0.711 | 7.24 | 8.59 | 5.16 | 4.96 | 0.93(0.02) |
| SG2 | AFHQ Cat | 0.993 | 0.991 | 0.972 | 6.35 | 7.87 | 1.65 | 2.32 | 0.97(0.01) |
| SG2 | AFHQ Dog | 0.999 | 0.998 | 0.981 | 3.80 | 5.36 | 9.76 | 12.33 | 0.95(0.01) |
| LDM | FFHQ | 0.996 | 0.364 | 0.872 | 12.34 | 13.63 | 4.50 | 4.35 | 0.94(0.01) |

Remarks: (1) Similar to the classic design of the experiment, one can reduce ∥ϵ_{ϕ}∥ by maximizing det(V^{T}H̅_{ϕ}V), which sets columns of V as the eigenvectors associated with the largest d_{ϕ}, eigenvalues of H̅_{ϕ}. However, H̅_{ϕ}, is neither computable because ϕ is unknown during the estimation, nor is it tractable because J_{w}_{_{ϕ}}_{(α)} is large in practice. To this end, it is proposed to use the covariance of p_{w}, denoted by Σ_{w}, to replace H̅_{ϕ}, in experiments. In Appendix C, we support this approximation empirically by showing that Σ_{w} and H̅_{w} (the non-fingerprinted mean Gram matrix) are qualitatively similar in that the principal dcomponents of both matrices offer disentangled semantic dimensions. (2) Let the kth largest eigenvalue of H̅_{w} be γₖ. By setting columns of V as the eigenvectors of H̅_{w} associated with the largest d_{ϕ}, eigen values, and by noting that \hat{ϕ} is accurate only when all of its elements match with ϕ ((1)), the worst case estimation error is governed by γ_{d}_{_{ϕ}}⁻¹. This means that higher key capacity, i.e., larger d_{ϕ}, leads to worse attribution accuracy. (3) From the proposition, ∈_{ϕ}=0 if V and U are complementary sets of eigenvectors of H̅_{ϕ}. In practice this decoupling between ϵ_{ϕ} and ϵ_{α} cannot be achieved due to the assumptions and approximations made.

Generation quality. For analysis purpose, this study approximates the original latent distribution p_{w}, by w=μ+Uα+Vβ where α˜ [symbol] (0, diag (λ_{U})), β˜ [symbol] (0, diag(λ_{V}), and μ= [symbol] _{w˜p}_{_{w}}[w]. λ_{U}∈ [symbol] ^{d}^{_{w}}^{-d}^{_{ϕ}} and λ_{V}∈ [symbol] ^{d}^{_{ϕ}} are calibrated to match p_{w}. Denote λ_{V,max}=maxᵢ{λ_{V,i}}. A latent distribution fingerprinted by ϕ is similarly approximated as w_{ϕ}=μ+Uα+σVϕ. With mild abuse of notation, let g be the mapping from the latent space to a feature space (usually defined by an Inception network in FID) and is continuously differentiable. Let the mean and covariance matrix of wᵢ be μᵢ and Σᵢ, respectively. Denote by H̅_{U}= [symbol] _{α}[J_{μ+U}_{₆₀} J_{μ+U}_{_{α}}] the mean Gram matrix in the subspace of U, and let γ_{U,max} be the largest eigenvalue of H̅_{U}. We have the following proposition to upper bound ∥μ₀−μ₁∥₂² and |tr(Σ₀)−tr(Σ₁)|, both of which are related to the FID score for measuring the generation quality (see Appendix A.2 for proof):

Proposition 3.2. For any τ>0 and η∈(0, 1), ∃c(τ, η)>0 and v>0, such that if σ≤c(τ, η) and λ_{V,i}≤c(τ, η) for all i=1, . . . , d_{ϕ}, then ∥μ₀−μ₁∥₂²≤σ²γ_{U,max}d_{ϕ}+τ and |tr(Σ₀−Σ₁)|≤λ_{V,max}γ_{U,max}d_{ϕ}+2vσ\sqrt{d_{ϕ}} with probability at least 1−η.

Remarks: Recall that for improving attribution accuracy, a practical approach is to choose V as eigenvectors associated with the largest eigenvalues of Σ_{w}. Notices that with approximated with α˜ [symbol] (0,diag(λ_{V})) and β˜ [symbol] (0, diag(λ_{V})), Σ_{w}=diag([λ_{U}^{T},λ_{V}^{T},]^{t}). On the other hand, from Proposition 3.2, generation quality improves if λ_{V,max} is minimized by choosing V according to the smallest eigenvalues of Σ_{w}. In addition, smaller key capacity (d_{ϕ}) and lower strength (σ) also improve the generation quality. Propositions 3.1 and 3.2 together reveal the intrinsic accuracy-quality tradeoff.

Generation quality. For analysis purpose, this study approximates the original latent distribution p_{w}, by w=μ+Uα+Vβ where α˜ [symbol] (0,diag(λ_{U})), β˜ [symbol] (0, diag(λ_{V})), and μ= [symbol] _{w˜p}_{_{w}}[w]. λ_{U}∈ [symbol] ^{d}^{_{w}}^{-d}^{_{ϕ}} and λ_{V}∈ [symbol] ^{d}^{_{ϕ}} are calibrated to match p_{w}. Denote λ_{V,max}=maxᵢ{λ_{V,i}}. A latent distribution fingerprinted by ϕ is similarly approximated as w_{ϕ}=μ+Uα+σVϕ. With mild abuse of notation, let g be the mapping from the latent space to a feature space (usually defined by an Inception network in FID) and is continuously differentiable. Let the mean and covariance matrix of wᵢ be μᵢ and Σᵢ, respectively. Denote by H̅_{U}= [symbol] _{α}[J^{T}_{μ+Uα}J_{μ+Uα}] the mean Gram matrix in the subspace of U, and let γ_{U,max} be the largest eigenvalue of H̅_{U}. We have the following proposition to upper bound ∥μ₀−μ₁∥₂² and |tr(Σ₀)−tr(Σ₁)|, both of which are related to the FID score for measuring the generation quality (see Appendix A.2 for proof):

Proposition 3.2. For any τ>0 and η∈(0, 1), ∃c(τ, η)>0 and v>0, such that if σ≤c(τ, η) and λ_{V,i}≤c(τ, η) for all i=1, . . . , d_{ϕ}, then ∥μ₀−μ₁∥₂²≤σ²γ_{U,max}d_{ϕ}+τ and |tr(Σ₀−Σ₁)|≤λ_{V,max}γ_{U,max}d_{ϕ}+2vσ\sqrt{d_{ϕ}} with probability at least 1−η.

Remarks: Recall that for improving attribution accuracy, a practical approach is to choose V as eigenvectors associated with the largest eigenvalues of Σ_{w}. Notices that with the approximated distribution with α˜ [symbol] (0,diag(λ_{V})) and β˜ [symbol] (0, diag(λ_{V})), Σ_{w}=diag([λ_{U}^{T},λ_{V}^{T},]^{t}). On the other hand, from Proposition 3.2, generation quality improves if λ_{V,max} is minimized by choosing V according to the smallest eigenvalues of Σ_{w}. In addition, smaller key capacity (d_{ϕ}) and lower strength (σ) also improve the generation quality. Propositions 3.1 and 3.2 together reveal the intrinsic accuracy-quality tradeoff.

### 4. Experiments

This section presents empirical evidence of the accuracy-quality tradeoff and show an improved tradeoff from the previous SOTA by using latent fingerprints. Experiments are conducted for both with and without a combination of postprocesses including (image noising, blurring, and JPEG compression, and their combination).

### 4.1 Experiment Settings

Models, data, and metrics. Experiments were conducted on SG2 and LDM models trained on various datasets including FFHQ, AFHQ-Cat, and AFHQ-Dog. Generation quality is measured by the Frechet Inception distance (FID) and inception score (IS), attribution accuracy by (1), and fingerprint secrecy by SSIM.

Latent fingerprint dimensions. To approximate Σ_{w}, 10K samples were drawn from p_{w} for SG2, which has a semantic latent space dimensionality of 512, and 50K samples were drawn from p_{w} for LDM, which has a semantic latent space dimensionality of 12,288. Define fingerprint dimensions V as a subset of eigenvectors of Σ_{w} associated with consecutive eigenvalues: V:=PC[i:j], where PC is the full set of principal components of Σ_{w}, sorted by their variances in the descending order while i and j represent the starting and ending indices of the subset.

Attribution. To compute the empirical accuracy (Eq. (1)), 1K samples drawn from p_{z} were used, for each fingerprint ϕ, and 1K fingerprints where each bit is drawn independently from a Bernoulli distribution with p=0.5. Table 1 shows that both constraints on \hat{α} and parallel search with 20 initial guesses improve the empirical attribution accuracy across models and datasets. Notably, constrained estimation is essential for the successful attribution of LDMs. In these experiments, V is chosen as the eigenvectors associated with the 64 smallest eigenvalues of Σ_{w}, as a worst-case scenario for attribution accuracy.

### 4.2 Attribution Performance Without Postprocessing

Table 1 presents generation quality results. Since the least variant principal components are used as fingerprints, generation quality (FID) and fingerprint secrecy (SSIM) are preserved.

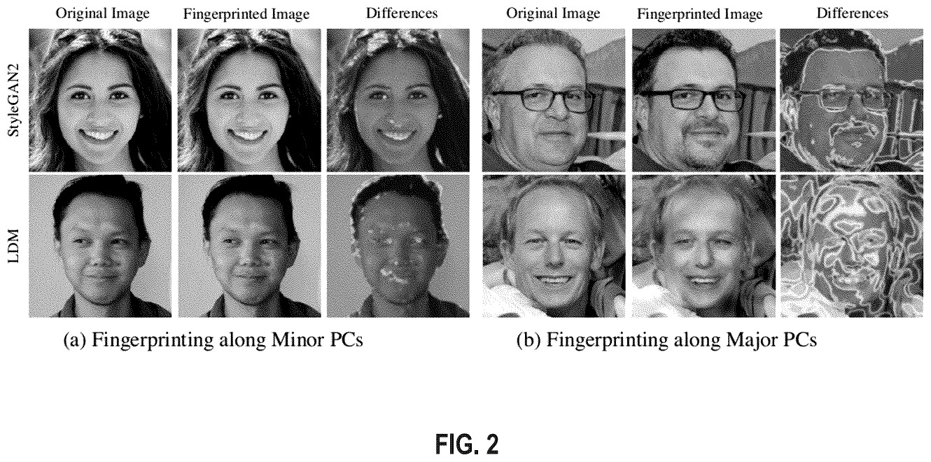

The results suggest that the attribution accuracy, generation quality, capacity (2⁶⁴), and fingerprint secrecy are all acceptable using the proposed method. FIG. 2 visualizes and compares latent fingerprints generated from small vs. large eigenvalues of Σ_{w}. Fingerprints corresponding to small eigenvalues are non-semantic, while those to large eigen values create semantic changes. Later it will be shown that semantic yet subtle (perceptually insignificant) fingerprints are necessary to counter image postprocesses.

Accuracy-quality tradeoff. Table 2 summarizes the trade off when the choice of V and the fingerprint strength σ are varied while fixing the fingerprint length d_{ϕ} to 64. In Table 3, d_{ϕ} is swept, while keeping V as PCs associated with smallest eigenvalues of Σ_{w}, and σ=1. The experiments were conducted on SG2 and LDM on the FFHQ dataset. The empirical results in Table 2 are consistent with the analysis: Accuracy decreases while generation quality improves when V is moved from major to minor principal components. For fingerprint strength, however, it was observed that the positive effect of strength on the accuracy, as predicted by Proposition 3.1, is only limited to small σ. This is because larger σ causes pixel values to go out of bounds, causing loss of information. Table 3 summarizes the attribution accuracy, FID, and SSIM score under 32- to 128-bit keys. Accuracy and generation quality, in particular the latter, are both affected by d_{ϕ}, as predicted.

4.3 Fingerprint Performance with Postprocessing

The following section considers more realistic scenarios where generated images are postprocessed, either maliciously as an attempt to remove the fingerprints or unintentionally, before they are attributed. Under this setting, the disclosed method achieves better accuracy-quality tradeoff than shallow fingerprinting under two realistic settings: (1) when noising and JPEG compression are used as unknown postprocesses, and (2) when the set of postprocesses, rather than the ones that are actually chosen, is known.

Postprocesses. To keep the solution realistic, the attribution problem is solved by assuming that the potential postprocesses are unknown:

$${min}_{\hat{α} , \hat{ϕ}} l ( g ( {w}_{\hat{ϕ}} ( \hat{α} ) ) , T ( {w}_{ϕ} ( α ) ) ) \\ s . t . {\hat{α}}_{i} ∈ [ {α}_{l , i} , {α}_{u , i} ] , ∀ i = 1 , … {d}_{w} - {d}_{ϕ}$$

where T:R^{d}^{ₓ}→R^{d}^{ₓ} is a postprocess function, and T(g(w_{ϕ}(α))) is a given image from which the fingerprint is to be estimated. The solution assumes that T does not change the image in a semantically meaningful way, because otherwise the value of the image for either an attacker or a benign user will be lost. Since the disclosed method adds semantically meaningful perturbations to the images, it is expected that such latent fingerprints will be more robust to postprocesses than shallow ones added directly to images and will lead to improved attribution accuracy. To test this hypothesis, the present study considers four types of postprocesses: Noising, Blurring, JPEG, and Combo. Noising adds a Gaussian white noise of standard deviation randomly sample from U[0, 0.1]. Blurring uses a randomly selected Gaussian kernel size from [3, 7, 9, 16, 25] and a standard deviation of [0.5, 1.0, 1.5, 2.0]. The JPEG quality is randomly sampled from [80, 70, 60, 50]. These parameters are chosen to be mild so that images do not lose their semantic contents. Combo randomly chooses a subset of the three through a binomial distribution with p=0.5 and uses the same postprocess parameters.

TABLE 2
Tradeoff between attribution accuracy (Att.) and generation quality (FID,
IS) under different fingerprinting directions (PC) and strength (σ).

| | | |
|---|---|---|
| σ = 0.6 | σ = 1.0 | σ = 6.0 |

| StyleGAN2 | Att. ↑ | FID ↓ | IS ↑ | Att. ↑ | FID ↓ | IS ↑ | Att. ↑ | FID ↓ | IS ↑ |
|---|---|---|---|---|---|---|---|---|---|
| PC[0:64] | 0.99 | 129.0 | 1.23 | 0.99 | 110.8 | 1.59 | 0.99 | 101.3 | 4.31 |
| PC[128:192] | 0.98 | 8.5 | 4.93 | 0.99 | 8.7 | 4.92 | 0.99 | 39.2 | 3.94 |
| PC[256:320] | 0.98 | 8.6 | 4.96 | 0.99 | 9.1 | 4.87 | 0.96 | 31.1 | 3.90 |
| PC[448:512] | 0.97 | 8.1 | 4.99 | 0.98 | 8.5 | 4.96 | 0.90 | 26.3 | 4.75 |

| | σ = 1.0 | | | σ = 2.0 | | | σ = 3.0 | | |
|---|---|---|---|---|---|---|---|---|---|
| LDM | Att. ↑ | FID ↓ | IS ↑ | Att. ↑ | FID ↓ | IS ↑ | Att. ↑ | FID ↓ | IS ↑ |
| PC[0.64] | 0.99 | 33.62 | 3.84 | 0.99 | 33.17 | 3.70 | 0.99 | 34.07 | 3.82 |
| PC[1000:1064] | 0.77 | 13.32 | 4.37 | 0.99 | 13.75 | 4.40 | 0.99 | 16.03 | 4.35 |
| PC[2000:2064] | 0.32 | 13.17 | 4.45 | 0.99 | 13.63 | 4.35 | 0.99 | 15.74 | 4.34 |
| PC[3000:3064] | 0.12 | 12.98 | 4.43 | 0.97 | 13.61 | 4.45 | 0.99 | 15.44 | 4.48 |
| PC[4000:4064] | 0.00 | 12.77 | 4.35 | 0.96 | 13.61 | 4.42 | 0.99 | 15.41 | 4.41 |

TABLE 3
Attribution accuracy (Att.) and generation
quality for different key lengths (d_{ϕ}).
FID-BL is the baseline FID score. ↑ (↓)
indicates higher (lower) is desired. The
standard deviation of SSIM is in parentheses.

| d_{ϕ} | Att. ↑ | FID-BL | FM ↓ | SSIM ↑ | IS ↑ |
|---|---|---|---|---|---|
| 32 | 0.982 | 7.24 | 8.49 | 0.96(0.01) | 4.90 |
| 64 | 0.983 | 7.24 | 8.59 | 0.92(0.02) | 4.96 |
| 96 | 0.981 | 7.24 | 9.50 | 0.90(0.02) | 4.93 |
| 128 | 0.973 | 7.24 | 9.61 | 0.87(0.03) | 4.91 |

Modified LPIPS metric. In addition to testing the worst-case scenario where postprocesses are completely unknown, cases where they are known are also considered. While this is unrealistic for individual postprocesses, it is worth investigating when assuming that the set of postprocesses, rather than the ones that are actually chosen, is known. This scenario shows that modifying LPIPS according to the postprocess improves the attribution accuracy. To explain, LPIPS is originally trained on a so called “two alternative forced choice” (2AFC) dataset. Each data point of 2AFC contains three images: a reference, p₀, and p₁, where p₀ and p₁ are distorted in different ways based on the reference. A human evaluator then ranks p₀ and p₁ by their similarity to the reference. Here, the following modification to the dataset is proposed for training postprocess specific metrics: Similar to 2AFC, for each data point, a reference image x is drawn from the default generative model to be fingerprinted and p₀ is defined as the fingerprinted version of x. p₁ is then a postprocessed version of x given a specific T (or random combinations for Combo). To match with the setting of 2AFC, 64×64 patches are sampled from x, p₀ and p₁ as training samples. The patches are then ranked from p₁ as being more similar to those of x than p₀. With this setting, the resulting LPIPS metric becomes more sensitive to fingerprints than mild postprocesses. The detailed training of the modified LPIPS follows the vgg-lin configuration in (Zhang et al., 2018). It should be noted that, unlike previous SOTA where shallow fingerprint or encoder-decoder models are retrained based on the known attacks, the present fingerprinting method, and therefore generalization performance, are agnostic to postprocesses.

Accuracy-quality tradeoff. Table 4 summarizes the fingerprint performance metrics on SG2 and FFHQ. The attribution accuracies reported here are estimated using the strongest parameters of each attack. For Combo, Blurring+Noising+JPEG is sequentially applied as a deterministic worst-case attack. To estimate attribution accuracy, the estimation problem in (4.3) is solved where postprocesses are applied. The proposed method: V was chosen as a subset of 32 consecutive eigenvectors of Σ_{w}, starting from the 1st, 17th, and 33rd eigenvectors, denoted respectively by PC[0:32], PC[16:48], and PC[32:64] in the table. Fingerprinting strength o was set to 3. Attribution results from both a standard and a postprocess specific LPIPS metric are reported in the UK (unknown) and KN (known) columns of Table 4, respectively. Accuracies for the disclosed method were computed based on 100 random fingerprint samples from 2³², each with 100 random generations. The baseline: A shallow fingerprinting method from (Kim et al., 2021) (denoted by BL). When the postprocesses are known, BL performs postprocess specific computation to derive shallow fingerprints that are optimally robust against the known postprocess. Results in UK and KN columns for BL are respectively without and with the postprocess specific fingerprint computation. BL accuracies are computed based on 10 fingerprints, each with 100 random generations.

TABLE 4
Comparison on accuracy-quality tradeoff between proposed and baseline methods under image postprocesses.
The experiments are tested using StyleGAN2-FFHQ. Fingerprinting strength σ = 3. The
FID score of the baseline method is 96.24. KN (UK) stands for when attribution accuracy is measured
with (without) the knowledge of the attack. The standard deviation is in parentheses.

| Metric | Model | Blurring | | Noising | | JPEG | | Combo | |
|---|---|---|---|---|---|---|---|---|---|
| — | — | KN | UK | KN | UK | KN | UK | KN | UK |
| Att. ↑ | BL (Kim et al., 2021) | 0.85 | 0.88 | 0.85 | 0.87 | 0.87 | 0.89 | 0.83 | 0.88 |
| | PC[0:32] | 0.79 | 0.99 | 0.99 | 0.99 | 0.98 | 0.99 | 0.82 | 0.99 |
| | PC[16:48] | 0.56 | 0.92 | 0.95 | 0.99 | 0.98 | 0.99 | 0.42 | 0.88 |
| | PC[32:64] | 0.32 | 0.83 | 0.93 | 0.98 | 0.98 | 0.99 | 0.26 | 0.79 |

| | | | | | |
|---|---|---|---|---|---|
| SSIM ↑ | BL (Kim et al., 2021) | 0.67(0.08) | 0.68(0.07) | 0.67(0.07) | 0.66(0.06) |
| | PC[0:32] | 0.27(0.04) | 0.27(0.04) | 0.27(0.04) | 0.27(0.04) |
| | PC[16:48] | 0.40(0.08) | 0.40(0.08) | 0.40(0.08) | 0.40(0.08) |
| | PC[32:64] | 0.56(0.07) | 0.56(0.07) | 0.56(0.07) | 0.56(0.07) |
| IS ↑ | BL (Kim et al., 2021) | 2.86 | 3.02 | 2.91 | 2.90 |
| | PC[0:32] | 2.93 | 2.93 | 2.93 | 2.93 |
| | PC[16:48] | 4.35 | 4.35 | 4.35 | 4.35 |
| | PC[32:64] | 4.50 | 4.50 | 4.50 | 4.50 |
| FID ↓, | BL (Kim et al., 2021) | 99.05 | 93.04 | 97.70 | 100.15 |
| | PC[0:32] | 102.26 | 102.26 | 102.26 | 102.26 |
| | PC[16:48] | 31.25 | 31.25 | 31.25 | 31.25 |
| | PC[32:64] | 27.50 | 27.50 | 27.50 | 27.50 |

TABLE 5
Accuracy-quality tradeoff under Combo attack. V is defined as the 8,
16, and 32 eigenvectors of Σ_{w}, starting from the 33rd eigenvectors.
σ = 3. KN (UK) stands for when attribution accuracy is measured
with (without) knowledge of attacks. The standard deviation is in parentheses.

| Model | Key Length | UK | KN | SSIM↑ | IS↑ | FID↓ |
|---|---|---|---|---|---|---|
| BL (Kim et al., 2021) | N/A | 0.83 | 0.88 | 0.66(0.06) | 2.90 | 100.15 |
| PC[32:40] | 8 | 0.65 | 0.89 | 0.73(0.06) | 4.75 | 12.35 |
| PC[32.48] | 16 | 0.45 | 0.85 | 0.65(0.06) | 4.86 | 13.25 |
| PC[32:64] | 32 | 0.26 | 0.79 | 0.57(0.07) | 4.50 | 27.50 |

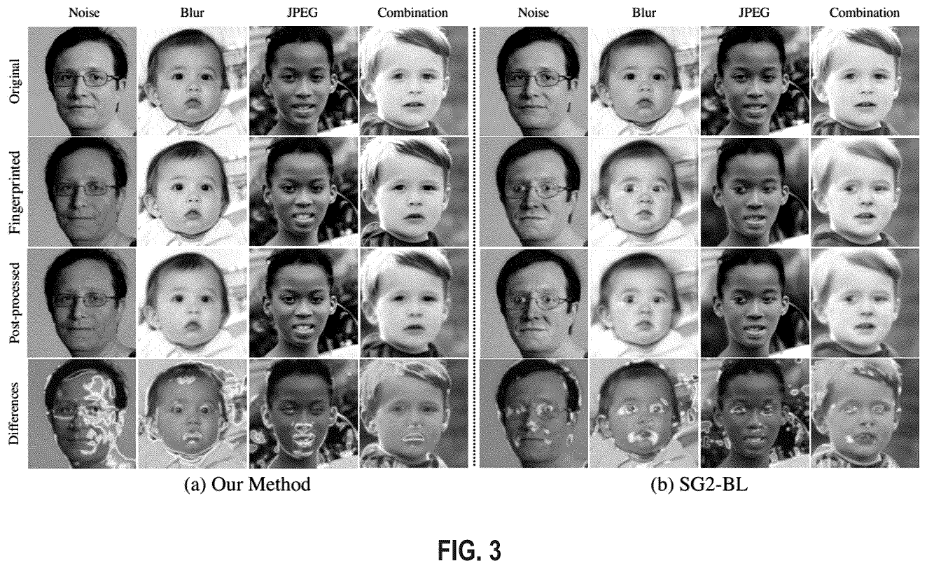

It is worth noting that the shallow fingerprinting method is not as scalable as the method presently disclosed (See Appendix: D, and increasing the key capacity decreases the overall attribution accuracy. Also, recall that the key length affects attribution accuracy (Proposition 1). Therefore, a fairer comparison to highlight the advantage of the disclosed method is conducted. Here a subset of fingerprints PC[32:40] (256 fingerprints) were chosen, the performance of which are reported in Table 5. Accuracies are computed using the same settings as before. Visual comparisons between the disclosed method (PC[32:40]) and the baseline are found in FIG. 3: To maintain attribution accuracy, high strength shallow fingerprints, in the form of color patches, are needed around eyes and noses, and significantly lower the generation quality. In comparison, the disclosed method uses semantic changes that are robust to postprocesses. The choice of semantic dimensions, however, needs to be carefully chosen for the fingerprint to be perceptually subtle.

Fingerprint secrecy. The secrecy of the fingerprint is evaluated through the SSIM which is designed to measure the similarity between two images by taking into account three components: loss of correlation, luminance distortion, and contrast distortion. To facilitate a more equitable comparison between the disclosed methodology and the baseline, a subset of fingerprints presented in Table 5 were selected for evaluation. As shown in Table 5, the robustly fingerprinted model for PC[32:40] exhibits superior fingerprint secrecy compared to the baseline, while simultaneously outperforming it in attribution accuracy. Besides these quantitative measures, the approach disclosed herein also demonstrates a qualitative advantage in terms of secrecy when compared to the baseline (see FIG. 3). This is largely attributed to the fact that subtle semantic variations across images are more challenging to visually detect and thus being removed compared to typical artifacts introduced by shallow fingerprinting.

### Non-Limiting Conclusions

The present disclosure investigated latent fingerprint as a solution to enable the attribution of generative models. The disclosed methods achieved a better tradeoff between attribution accuracy and generation quality than the previous SOTA that uses shallow fingerprints, and also has a lower computational cost compared to SOTA methods that require encoder-decoder training with high data complexity, rendering the disclosed method more scalable to attributing large models with high dimensional latent spaces.

Limitations and future directions: (1) There is currently a lack of certification on attribution accuracy due to the non-linear nature of both the fingerprinting and the fingerprint estimation processes. Formally, by considering both the generation and estimation processes as discrete time dynamics, such certification would require forward reachability analysis of fingerprinted contents and backward reachability analysis of the fingerprint, e.g., convex approximation of the support of p_{x,i} and \hat{ϕ}. It is worth investigating whether existing neural net certification methods can be applied. (2) The disclosed method extracts fingerprints from the training data. Even with feature decomposition, the amount of features that can be used as fingerprints is limited. Thus the accuracy-quality tradeoff is governed by the data. It would be interesting to see if auxiliary datasets can help to learn novel and perceptually insignificant fingerprints that are robust against postprocesses, e.g., background patterns.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

### Appendices

### Appendix A1.

Define=J_{w}∇g(w), H_{w}=J_{w}^{T}J_{w}, and H̅_{ϕ}= [symbol] _{α˜p}_{_{α}}[H_{Uα+σVϕ∅}], where p_{α} is induced by p_{w}. Let x_{ϕ}(α) be a content parameterized by (α, ϕ). Denote by ϵ_{α}=\hat{α}−α the estimation error from the ground truth parameter α. Assume that the estimate \hat{α}(α) is computed independent from ϕ, and ϵ_{α} is constant. Proposition 1 states:

Proposition 1. ∃c>0 such that if σ<c and |ϵ_{α}|₂≤c, the fingerprint estimation problem

$$\begin{matrix}min \\ ϕ\end{matrix} {𝔼}_{α \sim {p}_{α}} [ {‖ g ( U \hat{α} ( α ) + σ V \hat{ϕ} ) - {x}_{ϕ} ( α ) ‖}_{2}^{2} ] \\ has an estimation error {ϵ}_{ϕ} = - {( {σ}^{2} {V}^{T} {\overline{H}}_{ϕ} V )}^{- 1} {V}^{T} {\overline{H}}_{ϕ} {U}_{{ϵ}_{α}} . \\ Proof . Let x := g ( U {\hat{α}}_{ϕ} ( α ) + σ V ϕ ) , we have \\ \hat{x} = g ( U \hat{α} + σ V \hat{ϕ} ) = g ( U ( α + {ϵ}_{α} ) + σ V ( ϕ + {ϵ}_{ϕ} ) ) . \qquad ( 3 )$$

With Taylor's expansion, we have

$$\begin{matrix}\hat{x} = g ( U \hat{α} + σ V ϕ ) + {J}_{w} ( U {ϵ}_{α} + σ V {ϵ}_{ϕ} ) + o ( U {ϵ}_{α} + σ V {ϵ}_{ϕ} ) . \\ = {x}_{ϕ} ( α ) + {J}_{w} ( U {ϵ}_{α} + σ V {ϵ}_{ϕ} ) + o ( U {ϵ}_{α} + σ V {ϵ}_{ϕ} )\end{matrix} .$$

Ignoring higher-order terms we then have

$${‖ {x}_{ϕ} ( α ) - \hat{x} ‖}_{2}^{2} = {‖ {J}_{w} ( U {ϵ}_{α} + σ V {ϵ}_{ϕ} ) + o ( U {ϵ}_{α} + σ V {ϵ}_{ϕ} ) ‖}_{2}^{2} = {‖ {J}_{w} ( U {ϵ}_{α} + σ V {ϵ}_{ϕ} ) ‖}_{2}^{2} + {o ( U {ϵ}_{α} + σ V {ϵ}_{ϕ} )}^{T} {J}_{w} ( U {ϵ}_{α} + σ V {ϵ}_{ϕ} ) .$$

For any τ>0, there exists c, such that if τ≤c and |ϵ_{α}|₂≤c,

$${‖ {x}_{ϕ} ( α ) - \hat{x} ‖}_{2}^{2} \leq {‖ {J}_{w} ( U {ϵ}_{α} + σ V {ϵ}_{ϕ} ) ‖}_{2}^{2} + τ = {σ}^{2} {ϵ}_{ϕ}^{T} {V}^{T} {H}_{w} {V}_{{ϵ}_{ϕ}} + 2 {ϵ}_{ϕ}^{T} {V}^{T} {H}_{w} U {ϵ}_{α} T + {ϵ}_{α}^{T} {U}^{T} {H}_{w} U {ϵ}_{α} + τ .$$

Removing terms independent from ϵ_{ϕ} to reformulate (3) as

$${min}_{{ϵ}_{ϕ}} {σ}^{2} {ϵ}_{ϕ}^{T} {V}^{T} {\overline{H}}_{ϕ} {V}_{{∈}_{ϕ}} + 2 {ϵ}_{ϕ}^{T} {V}^{T} {\overline{H}}_{ϕ} U {ϵ}_{α}$$

the solution of which is

$${ϵ}_{ϕ} = - {( {σ}^{2} {V}^{T} {\overline{H}}_{ϕ} V )}^{- 1} {V}^{T} {\overline{H}}_{ϕ} U {ϵ}_{α} .$$

### Appendix A2.

Consider two distributions: The first is w₀=μ+Uα+Vβ where μ∈ [symbol] ^{d}^{_{w}}, α˜ [symbol] (0, diag(λᵤ)), and β˜ [symbol] (0, diag(λ_{V})). diag(λ) is a diagonal matrix where diagonal elements follow λ. The second distribution is w₁=μ+Uα+σVϕ where σ>0 and ϕ∈{0,1}^{d}^{_{ϕ}}. Let g: [symbol] ^{d}^{_{w}}→ [symbol] ^{d}^{ₓ}∈C¹. Let the mean and covariance matrix of wᵢ be μᵢ and Σᵢ. Denote by H̅_{U}= [symbol] _{α}[J^{T}_{μ+Uα}J_{μ+Uα}] the mean Gram matrix, and let γ_{U,max} be the largest eigenvalue of H̅_{U}. Proposition 2 states:

Proposition 2. For any τ>0 and η∈(0, 1), there exists c(τ, η)>0 and v>0, such that if σ<c(τ, η) and λ_{V,i}≤c(τ, 72 ) for all i=1, . . . d_{ϕ}, ∥μ₀−μ₁∥₂²≤σ₂γ_{U,max}d_{ϕ}+η and |tr(Σ₀−Σ₁)|≤λ_{V,max}γ_{U,max}d_{ϕ}+2vσ\sqrt{d_{ϕ}}+η with probability at least 1−η.

Proof. We start with ∥μ₀−μ₁∥₂². From Taylor's expansion and using the independence between α and β, we have

$$\begin{matrix}{μ}_{0} := {𝔼}_{α , β} [ g ( μ ) + U α + V β ] \\ = {𝔼}_{α} [ g ( μ + U α ) ] + {𝔼}_{α , β} [ {J}_{μ + U α} V β + o ( {J}_{μ + U α} V β ) ] + \\ = {𝔼}_{α} [ g ( μ + U α ) ] + {𝔼}_{α , β} [ o ( {J}_{μ + U α} V β ) ] ,\end{matrix} \qquad ( 4 )$$

$$\begin{matrix}{μ}_{1} := {𝔼}_{α} [ g ( μ + U α + σ V ϕ ) ] \\ = {𝔼}_{α} [ g ( μ + U α ) ] + o ( σ {J}_{μ + U α} V ϕ ) + σ {𝔼}_{α} [ {J}_{μ + U α} V ϕ ] \\ = {μ}_{0} + {σ𝔼}_{α} [ {J}_{μ + U α} V ϕ ] + {𝔼}_{α , β} [ o ( {J}_{μ + U α} V ( σ ϕ - β ) ) ] .\end{matrix}$$

Let v=Vϕ. With orthonormal V and binary-coded ϕ, we have

$${‖ v ‖}_{2}^{2} = {ϕ}^{T} {V}^{T} V ϕ = {‖ ϕ ‖}_{2}^{2} \leq {d}_{ϕ} \qquad ( 5 )$$

For the residual term ∥ [symbol] _{α,β}[o(J_{μ+Uα}V(σϕ−β))]∥₂² and any τ>0 and η∈(0,1), there exists c(τ, η)>0, such that if σ≤c(τ, η) and λ_{V,i}≤c(τ, η) for all i=1, . . . , d_{ϕ} we have

$$Pr ( {‖ {𝔼}_{α , β} [ o ( {J}_{μ + U α} V ( σ ϕ - β ) ) ] ‖}_{2}^{2} \leq τ ) \geq 1 - η \qquad ( 6 )$$

Lastly, we have

$${‖ {E}_{α} [ {J}_{μ + U {α}^{V}} ] ‖}_{2}^{2} \leq {𝔼}_{α} [ {v}^{T} {J}_{μ\_ U α}^{T} {J}_{μ + U α} v ] = {v}^{T} {H}_{U} v \leq γ U , max {‖ v ‖}_{2}^{2} \leq {γ}_{U , max} {d}_{ϕ} . \qquad ( 7 )$$

Then combining (11), (5), (6), (7), we have with probability at least 1−η

$${‖ {μ}_{0} - {μ}_{1} ‖}_{2}^{2} \leq {σ}^{2} {γ}_{U , max} {d}_{ϕ} + τ . \qquad ( 8 )$$

For covariances, let Σ_{U}=Cov(g(μ+Uα)). We have

$$\begin{matrix}{\sum }_{0} = {𝔼}_{α , β} [ ( g ( μ + U α + V β ) - {μ}_{0} ) {( g ( μ + U α + V β ) - {μ}_{0} )}^{T} ] \\ = {\sum }_{U} + {𝔼}_{α} [ {J}_{μ + U α} V diag ( λ v ) {V}^{T} {J}_{μ + U α}^{T} ] + \\ {𝔼}_{α , β} [ o ( {J}_{μ + U α} V β ) {( g ( μ + U α + V β ) - {μ}_{0} )}^{T} ]\end{matrix} \qquad ( 9 )$$

$$\begin{matrix}{\sum }_{1} = {𝔼}_{α} [ ( g ( μ + U α + σ V ϕ ) - {μ}_{1} ) {( g ( μ + U α + σ V ϕ ) - {μ}_{1} )}^{T} ] \\ = {\sum }_{U} + {σ}^{2} Cov ( {J}_{μ + U α} V {ϕ}^{*} ) + \\ 2 σCov ( g ( μ + U α ) , {J}_{μ + U α} V ϕ + o ( {J}_{μ + U α} V ϕ ) ) .\end{matrix}$$

For tr(Σ₀), using the same treatment for the residual, we have for any τ>0 and η∈(0,1), there exists c(τ, η)>0, such that if λ_{V,i}≤c(τ, η) for all i=1, . . . , d_{ϕ}, the following upper bound applies with at least probability 1−η:

$$\begin{matrix}tr ( {\sum }_{0} ) \leq tr ( {\sum }_{U} ) + tr ( {𝔼}_{a} [ {J}_{μ + U α} V diag ( {λ}_{V} ) {V}^{T} {J}_{μ + U α}^{T} ] ) + τ \\ \leq tr ( {\sum }_{U} ) + {λ}_{V , max} tr ( {\sum }_{α} [ {J}_{μ + {U}_{α}} V {V}^{T} {J}_{μ + U α}^{T} ] ) + τ \\ = tr ( {\sum }_{U} ) + {λ}_{V , max} tr ( {\sum }_{α} [ {V}^{T} {J}_{μ + U α}^{T} {J}_{μ + U α} V ] ) + τ \\ \leq tr ( {\sum }_{U} ) + {λ}_{V , max} {γ}_{U , max} t r ( {V}^{T} V ) + τ \\ \leq tr ( {\sum }_{U} ) + {λ}_{V , max} {γ}_{U , max} {d}_{ϕ} + τ .\end{matrix} \qquad ( 10 )$$

For the lower bound, we have tr(Σ₀)≥tr(Σ_{U}).

For tr(Σ₁), we first denote by Jᵢ^{T} the ith row of J_{μ+Uα}, Σ_{Ji} its covariance matrix, and σᵢ² the maximum eigenvalue of Σ_{Ji}. Then with binary-coded ϕ, we have

$$Var ( {J}_{i}^{T} V ϕ ) = {ϕ}^{T} {V}^{T} Cov ( {J}_{i} ) V ϕ \leq {σ}_{i}^{2} {d}_{ϕ} \qquad ( 11 )$$

Then let gᵢ(resp. vᵢ) be the ith element of g(μ+Uα) (resp. J_{μ+Uα}Vϕ), and σ_{U,i}² be the ith diagonal element of Σ_{U}. Using (11), we have the following bound on the trace of the covariance between g(μ+Uα) and J_{μ+Uα}Vϕ

$$\vert tr ( Cov ( g ( μ + U α ) {J}_{μ + U α} V ϕ ) ) \vert = \vert {\sum }_{i = 1}^{{d}_{x}} Cov ( {g}_{i} , {v}_{i} ) \vert \leq {\sum }_{i = 1}^{{d}_{x}} {σ}_{U , i} {σ}_{i} \sqrt{{d}_{ϕ}} \qquad ( 12 )$$

Lastly, by ignoring σ² terms and borrowing the same τ, η, and c(τ, η), we have with probability at least 1−η:

$$tr ( {\sum }_{1} ) \leq tr ( {\sum }_{U} ) + 2 σ tr ( Cov ( g ( μ + U α ) {J}_{μ + U α} V ϕ ) ) + τ \leq tr ( {\sum }_{U} ) + 2 σ {\sum }_{i = 1}^{{d}_{x}} {σ}_{U , i} {σ}_{i} \sqrt{{d}_{ϕ}} + τ , \\ and \qquad ( 13 )$$

$$tr ( {\sum }_{1} ) \geq tr ( {\sum }_{U} ) - 2 σ {\sum }_{i = 1}^{{d}_{x}} {σ}_{U , i} {σ}_{i} \sqrt{{d}_{ϕ}} . \qquad ( 14 )$$

Therefore, with probability at least 1−η

$$tr ( {\sum }_{0} ) - tr ( {\sum }_{1} ) \leq {λ}_{V , max} {γ}_{U , max} {d}_{ϕ} + 2 σ {\sum }_{i = 1}^{{d}_{x}} {σ}_{U , i} {σ}_{i} \sqrt{{d}_{ϕ}} + τ , \\ and \qquad ( 15 )$$

$$tr ( {\sum }_{0} ) - tr ( {\sum }_{1} ) \geq - 2 σ {\sum }_{i = 1}^{{d}_{x}} {σ}_{U , i} {σ}_{i} \sqrt{{d}_{ϕ}} - τ . \qquad ( 16 )$$

### Convergence on α

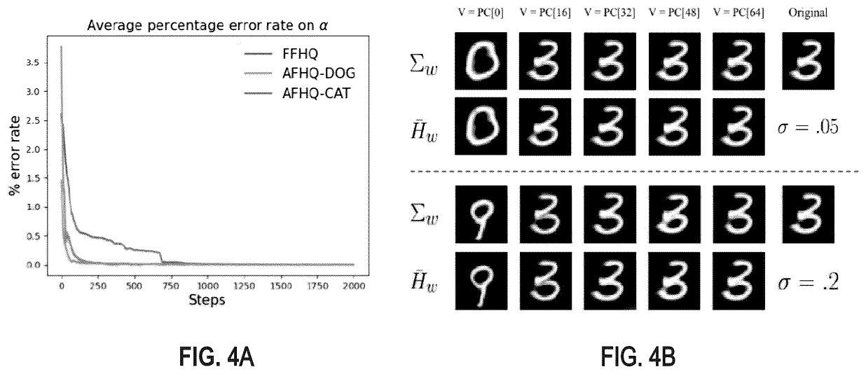

In the proofs, it is assumed that ∥ϵ_{α}∥₂ is small and constant. Here it is shown that empirical estimation results on SG2 and on FFHQ, AFHQ-DOG, AFHQ-CAT datasets. The results in FIG. 4(a) are averaged over 100 random α and 100 random ϕ, and uses parallel search on α during the estimation.

Qualitative Similarity Between H̅_{ω} and Σ_{ω}

Since computing H̅_{ω} for large models is intractable, here a SG2 is trained on MNIST to estimate H̅_{ω}. FIG. 4(b) summarizes perturbed images from a randomly chosen reference along principal components of H̅_{ω} and Σ_{ω}. Note that both have quickly diminishing eigenvalues. Therefore, most components other than the few major ones lead to imperceptible changes in the image space.

Computational Complexity and Efficiency Comparison of Proposed and Baseline Methods.

To comprehensively evaluate the computational costs of the proposed and baseline methods, each were analyzed from two perspectives: fingerprint generation and attribution. The proposed method demonstrates a significant increase in efficiency compared to existing methods with regards to fingerprint generation. However, current methods, such as those proposed in (Kim et al., 2021), often necessitate a considerable amount of time for fine-tuning the model before generating a fingerprinted image. For instance, the baseline method requires approximately one hour to fine-tune the model for each individual user. For a key capacity of 2³² users, it would take an estimated 2³² hours to train on an NVIDIA V100 GPU. In contrast, the proposed method does not require the model to be fine-tuned, and only requires Principal Component Analysis (PCA) to be performed on the latent space of each pre-trained model to identify the editing direction. This process takes approximately three seconds for a key capacity of 2³².

Regarding attribution time, the baseline approach performs attribution through a pre-trained network, resulting in low computation cost during inference. On the other hand, the proposed method uses optimization techniques to perform attribution, resulting in a longer computation time. Specifically, the average attribution time for the baseline method is approximately two seconds, while the proposed method takes approximately 126 seconds on average for 1 k optimization trials (in parallel) using an NVIDIA V100 GPU.

It is important to acknowledge that there exists a trade-off between computational costs during generation and attribution. The choice of which aspect is more critical may depend on the specific application requirements.

### Ablation Study

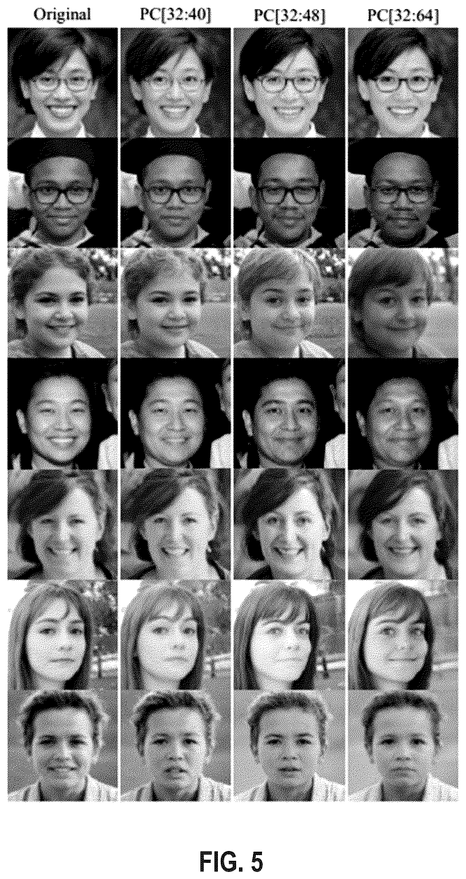

In this section, attribution accuracy was estimated based on various attack parameters with multiple editing directions (see Table (Tab.) 6, 7, 8, 9). The image quality evaluation is available in Tab. 10 and more visualizations can be found in FIG. 5.

TABLE 6
Attributability Table of Blurring attack. σ refers standard deviation
of Gaussian Blur filter size 25. When attributability is measured
with (without) knowledge of attack, we put results under KN (UK).

| Metric | Model | σ = 0.5 | | σ = 1.0 | | σ = 1.5 | | σ = 2.0 | |
|---|---|---|---|---|---|---|---|---|---|
| — | — | UK | KN | UK | KN | UK | KN | UK | KN |
| Att. ↑ | BL | 0.88 | 0.89 | 0.87 | 0.89 | 0.87 | 0.88 | 0.85 | 0.88 |
| | PC[32:40] | 0.99 | 0.99 | 0.95 | 0.99 | 0.90 | 0.99 | 0.53 | 0.92 |
| | PC[32:48] | 0.99 | 0.99 | 0.97 | 0.99 | 0.72 | 0.92 | 0.38 | 0.88 |
| | PC[32:64] | 0.99 | 0.99 | 0.73 | 0.94 | 0.51 | 0.90 | 0.32 | 0.83 |

TABLE 7
Attributability Table of Noise attack. σ refers standard deviation
of Gaussian normal distribution. When attributability is measured
with (without) knowledge of attack, we put results under KN (UK).

| Metric | Model | σ = 0.025 | | σ = 0.05 | | σ = 0.075 | | σ = 0.1 | |
|---|---|---|---|---|---|---|---|---|---|
| — | — | UK | KN | UK | KN | UK | KN | UK | KN |
| Att. ↑ | BL | 0.87 | 0.88 | 0.86 | 0.88 | 0.86 | 0.87 | 0.85 | 0.87 |
| | PC[32:40] | 0.99 | 0.99 | 0.99 | 0.99 | 0.99 | 0.99 | 0.99 | 0.99 |
| | PC[32:48] | 0.99 | 0.99 | 0.97 | 0.99 | 0.94 | 0.99 | 0.95 | 0.99 |
| | PC[32:64] | 0.98 | 0.99 | 0.95 | 0.99 | 0.92 | 0.98 | 0.93 | 0.98 |

TABLE 8
Attributability Table of JPEG attack. Q refers quality metric of
JEPG compression. When attributability is measured with (without)
knowledge of attack, the results were placed under KN (UK).

| Metric | Model | Q = 80 | | Q = 70 | | Q = 60 | | Q = 50 | |
|---|---|---|---|---|---|---|---|---|---|
| — | — | UK | KN | UK | KN | UK | KN | UK | KN |
| Att. ↑ | BL | 0.88 | 0.89 | 0.87 | 0.89 | 0.87 | 0.89 | 0.87 | 0.89 |
| | PC[32:40] | 0.99 | 0.99 | 0.99 | 0.99 | 0.99 | 0.99 | 0.99 | 0.99 |
| | PC[32:48] | 0.99 | 0.99 | 0.99 | 0.99 | 0.99 | 0.99 | 0.99 | 0.99 |
| | PC[32:64] | 0.99 | 0.99 | 0.99 | 0.99 | 0.99 | 0.99 | 0.98 | 0.99 |

TABLE 9
Attributability Table of combination attack. From T1 to T4, the
attack parameters are composed of the weakest to the strongest
attack parameters of each attack (e.g., T4 is [σ_{blur} = 2.0, σₙₒᵢₛₑ =
0.2, Q_{JPEG} = 50]). When attributability is measured with (without)
knowledge of attack, the results were placed under KN (UK).

| Metric | Model | T1 | | T2 | | T3 | | T4 | |
|---|---|---|---|---|---|---|---|---|---|
| — | — | UK | KN | UK | KN | UK | KN | UK | KN |
| Att. ↑ | BL | 0.86 | 0.88 | 0.86 | 0.87 | 0.85 | 0.86 | 0.83 | 0.88 |
| | PC[32:40] | 0.99 | 0.99 | 0.94 | 0.99 | 0.81 | 0.95 | 0.65 | 0.89 |
| | PC[32:48] | 0.99 | 0.99 | 0.74 | 0.92 | 0.52 | 0.88 | 0.45 | 0.85 |
| | PC[32:64] | 0.99 | 0.99 | 0.63 | 0.90 | 0.41 | 0.82 | 0.26 | 0.79 |

TABLE 10
Quality Comparison Table. Standard deviations are in
parentheses. The baseline score is in the parentheses.

| | FID | | |
|---|---|---|---|
| Model | (7.24)↑ | IS (4.95) ↑ | SSIM↑ |
| BL_{Blur} | 99.05 | 2.86 (0.35) | 0.67(0.08) |
| BL_{Noise} | 93.04 | 3.02 (0.27) | 0.68(0.07) |
| BL_{JPEG} | 97.70 | 2.91 (0.26) | 0.67(0.07) |
| B1_{Combo} | 100.15 | 2.90 (0.23) | 0.66(0.06) |
| PC[32:40] | 12.35 | 4.75 (0.05) | 0.73(0.06) |
| PC[32:48] | 13.25 | 4.86 (0.08) | 0.65(0.06) |
| PC[32:64] | 27.50 | 4.50 (0.07) | 0.57(0.07) |

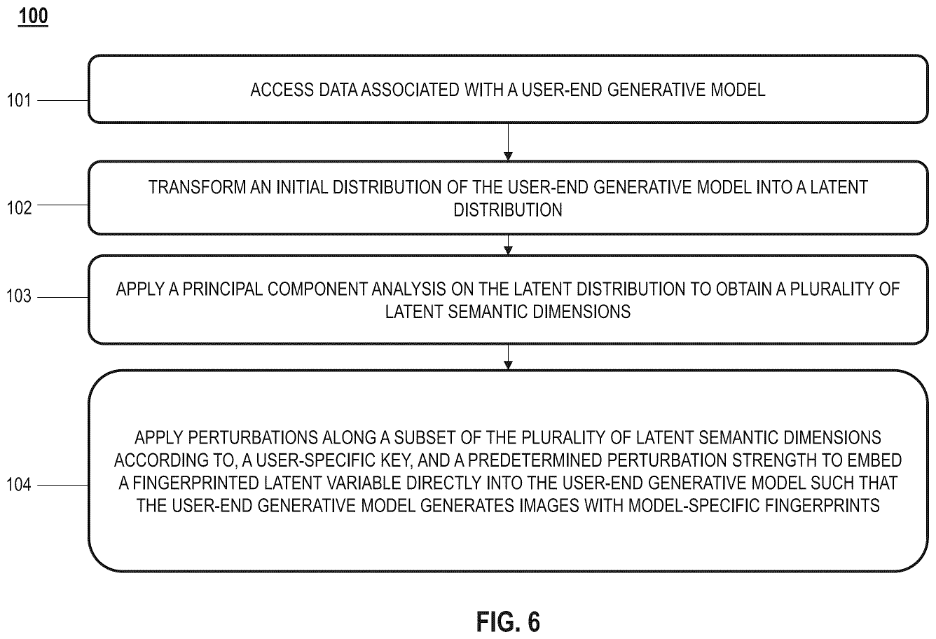

Exemplary Method/Process: Referring to FIG. 6, an example method or process is provided which can be implemented as machine readable instructions and/or via any type or number of processing elements.

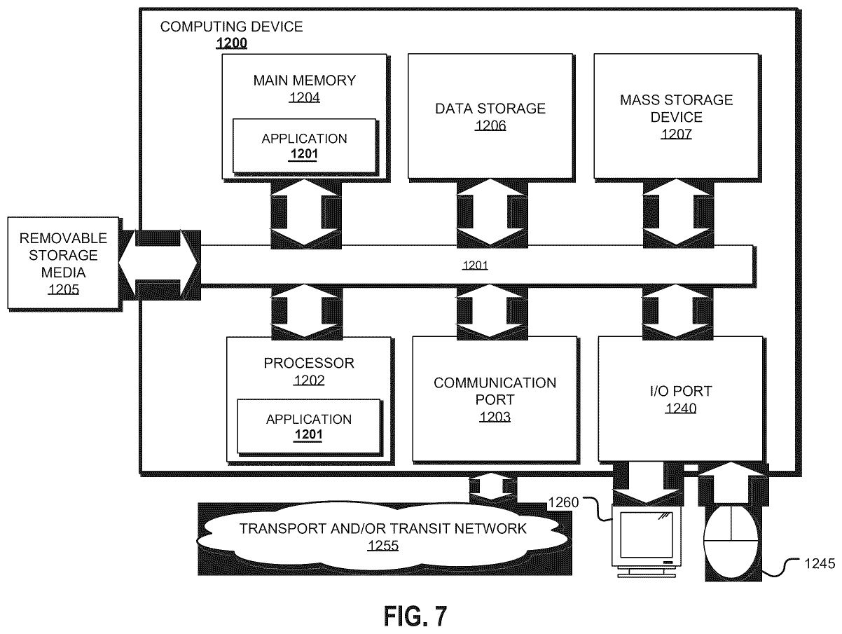

Exemplary Computing Device: Referring to FIG. 7, a computing device 1200 is illustrated which may can be configured, via one or more of an application 1211 or computer-executable instructions, to execute functionality described herein. More particularly, in some embodiments, aspects of the methods herein may be translated to software or machine-level code, which may be installed to and/or executed by the computing device 1200 such that the computing device 1200 is configured to execute functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

The described methods, processes, operations, and associated actions may also be performed in various orders in addition to the order described in this application, in parallel, and/or simultaneously. The described systems are exemplary in nature and may include additional elements and/or omit elements. Furthermore, references to or “one example” of the present disclosure are not intended to be interpreted as excluding the existence of additional embodiments that also incorporate the recited features. It will be understood that when a certain part or process “includes” a certain component or operation, that part or process does not exclude another component or operation. While illustrative examples of the name screening techniques using phonetic embeddings have been described herein including systems, devices, and the like, it is to be understood that various other adaptations and modifications may be made within the spirit and the scope of the examples herein. Additionally, it is appreciated that while specific graphics are shown and described, such graphics are illustrative and exemplary and are not intended to limit the scope of this disclosure.

The foregoing description has been directed to specific examples. It will be apparent, however, that other variations and modifications may be made to the described examples, with the attainment of some or all of their advantages. For instance, it is expressly contemplated that the components and/or elements described herein can be implemented as software being stored on a tangible (non-transitory) computer-readable medium, devices, and memories (e.g., disks/CDs/RAM/EEPROM/etc.) having program instructions executing on a computer, hardware, firmware, or a combination thereof. Further, methods describing the various functions and techniques described herein can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on. In addition, devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example. Instructions, media for conveying such instructions, computing resources for executing them, and other structures for supporting such computing resources are means for providing the functions described in these disclosures. Accordingly, this description is to be taken only by way of example and not to otherwise limit the scope of the examples herein. Therefore, it is the object of the appended claims to cover all such variations and modifications as come within the true spirit and scope of the examples herein.

In addition, the description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for improved generative model image attribution, comprising:
accessing, by a processor, a machine-readable storage medium containing instructions executable by the processor to:
transform an initial distribution of a user-end generative model into a latent distribution;
apply a principal component analysis on the latent distribution to obtain a plurality of latent semantic dimensions; and
apply perturbations along a subset of the plurality of latent semantic dimensions according to, a user-specific key, and a predetermined perturbation strength to embed a fingerprinted latent variable directly into the user-end generative model such that the user-end generative model generates images with model-specific fingerprints.

2. The method for improved generative model image attribution of claim 1, wherein the initial distribution is a Gaussian distribution.

3. The method for improved generative model image attribution of claim 1, wherein in the model is pretrained.

4. The method for improved generative model image attribution of claim 1, wherein the subset of the plurality of semantic dimensions comprise an orthonormal dimension and a complementary dimension.

5. The method for improved generative model image attribution of claim 1, wherein the perturbations applied along the subset of the plurality of latent dimensions are linear perturbations.

6. The method for improved generative model image attribution of claim 1, wherein the perturbations are further applied along the subset of the plurality of latent dimensions according to a random seed.

7. The method for improved generative model image attribution of claim 1, wherein the latent semantic dimensions are imperceptible dimensions based on latent variables of the latent distribution.

8. The method for improved generative model image attribution of claim 1, wherein the model-specific fingerprints are semantically meaningful perturbations to a generated image such that an attribution accuracy of the model-specific fingerprints is resistant to postprocesses.

9. The method for improved generative model image attribution of claim 8, wherein the postprocesses include noising, blurring, reformatting to .jpeg, or a combination thereof.

10. The method for improved generative model image attribution of claim 1, wherein the method further comprises:
decoding, by the processor, the user-specific key from a generated image.
